(19) United States
(12) Patent Application Publication
(10) Pub. No.: US 2005/0028171 A1
(43) Pub. Date: Feb. 3, 2005

(54) System and method enabling multiple processes to efficiently log events

(76) Inventors: Panagiotis Kougiouris, San Jose, CA (US); Mac Vu, Milpitas, CA (US)

Correspondence Address: JONES DAY, 222 EAST 41ST ST, NEW YORK, NY, 10017, US

(21) Appl. No.: 10/690,343

(22) Filed: Oct. 20, 2003

Related U.S. Application Data
(63) Continuation of application No. 09/439,374, filed on Nov. 15, 1999, now abandoned.
(60) Provisional application No. 60/165,127, filed on Nov. 12, 1999.
(60) Provisional application No. 60/165,118, filed on Nov. 12, 1999.

(51) Int. Cl. G06F 9/00

(52) U.S. Cl. 719/318

(57) ABSTRACT

A system and method for enabling multiple processes to efficiently log events is described. A client executable module that needs to log an event may interface with a module or component referred to as a “client-side logging component”, passing various types of information regarding the event, such as an associated event level, one or more event associated event categories, an informational message, etc. The client-side logging component may maintain event logging criteria specifying which types of events should be logged. If the event should be logged, the client-side logging component may queue the event information and return execution control the client module. The event information may then be asynchronously retrieved from the event queue and sent to a server-side logging component. The server-side logging component may persistently log the event information in any of various ways, e.g., by storing it in a file, a database, etc. Processes running on multiple computers may call the server-side logging component to log events, via a client-side logging component instance associated with the process. A logging administration tool may be utilized in order to set event logging criteria. In response to being configured with new event logging criteria information, the server-side logging component may automatically propagate the logging criteria information to each of the client-side logging components. The client-side logging components may then being using the new logging criteria, dynamically changing the filtering of events that are sent to the server-side logging component.

### PRIORITY CLAIM

This application claims benefit of priority of U.S. provisional application Serial No. titled “System and Method Enabling Multiple Processes to Efficiently Log Events”, filed Nov. 12, 1999, whose inventor was Panagiotis Kougiouris.

### RESERVATION OF COPYRIGHT

A portion of the disclosure of this patent document contains material to which a claim of copyright protection is made. The copyright owner has no objection to the facsimile reproduction by anyone of the patent document or the patent disclosure as it appears in the Patent and Trademark Office patent file or records, but reserves all other rights whatsoever.

### FIELD OF THE INVENTION

The present invention relates to the field of computer programs, and more particularly to a system and method for enabling multiple processes to efficiently log events.

### DESCRIPTION OF THE RELATED ART

During operation of a system or application, it is often desirable to record information about various types of actions, operations, or situations that occur. Recording such information is known as “logging an event”. A system or application may log an event for any of various purposes, e.g., to record performance information, to record information related to system security, to record debugging information, to record other informational messages regarding runtime operation of an application, etc.

As distributed systems and applications have continued to proliferate, it has become more important to provide flexible means enabling client executable modules to easily and reliably log events to a central event log. When a client executable module needs to log an event, the client module may call an event logging service. One drawback of many prior art event logging systems and methods is that the event logging service may synchronously log the event, while the calling module waits. It may instead be desirable to enable client modules to notify an event service of an event and then resume execution as quickly as possible. The event service may then log the event asynchronously, which may involve persistently storing the event in a remote location, etc.

Also, many prior art event logging services execute out-of-process from calling modules. Performing inter-process communication when logging events may result in significant performance degradation, especially for client modules that log many events. It may instead be desirable to enable a client module to interface with an event service that executes in-process with the module, thus avoiding any possible overhead involved in process-switching.

As noted above, systems and applications may log events for many different purposes. Many of these events may not need to be logged at all times. For example, application developers often include calls to log informational messages, for development or debugging purposes. For day-to-day operation of a system or application, it may not be necessary or desirable to log these types of events. Thus, it may be desirable to enable event filtering criteria to be specified, e.g., using a logging administration tool.

As noted above, distributed systems and applications often maintain a centralized event log or database. It may be desirable to enable new event logging criteria to be specified and have the criteria information be automatically propagated to each client, so that clients dynamically alter the types of events they send to the centralized event log, without requiring code to be recompiled, or the event service to be re-started, etc.

### SUMMARY OF THE INVENTION

The problems outlined above may in large part be solved by providing a system and method for enabling multiple processes to efficiently log events, as described herein. A client executable module that needs to log an event may interface with a module or component referred to as a “client-side logging component”. In one embodiment, the client-side logging component executes in process with the client module. The client module may pass the client-side logging component various types of information regarding the event, such as an associated event level, one or more associated event categories, an informational message, etc.

A computer system process may have multiple executable modules that are associated with the process, such as DLLs, shared libraries, component objects, etc. For a particular process, each associated module may interface with a single instance of a client-side logging component. The client-side logging component instance for each process may interface with a central server-side logging component instance. Processes running on multiple computers may call the server-side logging component to log events, via the client-side logging component instance for the process.

A logging administration tool may be utilized in order to set event logging criteria. For example, the logging administration tool may enable an administrator to specify that only events of particular levels should be logged, or that only events associated with certain event categories should be logged, etc. In response to being configured with new event logging criteria information, the server-side logging component may automatically propagate the logging criteria information to each of the client-side logging components. The client-side logging components may then begin using the new logging criteria, dynamically changing the filtering of events that are sent to the server-side logging component.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram illustrating one embodiment of a system for logging events for multiple processes;

FIGS. 2A and 2B illustrate exemplary embodiments of the distribution of FIG. 1 elements;

FIG. 3 illustrates an exemplary graphical user interface for a logging administration tool;

FIG. 4 illustrates an embodiment of a client-side logging component;

FIG. 5 is a flowchart diagram illustrating one embodiment of a process of initiating a request to log an event;

FIG. 6 is a flowchart diagram illustrating one embodiment of a process of a client-side logging component asynchronously retrieving events from an event queue and sending the events to the server-side logging component; and

FIG. 7 is a flowchart diagram illustrating one embodiment of a process of automatically updating the event-logging criteria maintained by client-side logging components.

While the invention is susceptible to various modifications and alternative forms, specific embodiments are shown by way of example in the drawings and are herein described in detail. It should be understood however, that drawings and detailed description thereto are not intended to limit the invention to the particular form disclosed. But on the contrary the invention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The following references are hereby incorporated by reference.

For information on the Component Object Model, please refer to:
Box, Essential COM, Addison-Wesley, 1998; or to
Grimes, et al, Beginning ATL COM Programming, Wrox Press, 1998.

For information on the Distributed Component Object Model, please refer to:
Grimes, Professional DCOM Programming, Wrox Press, 1997.

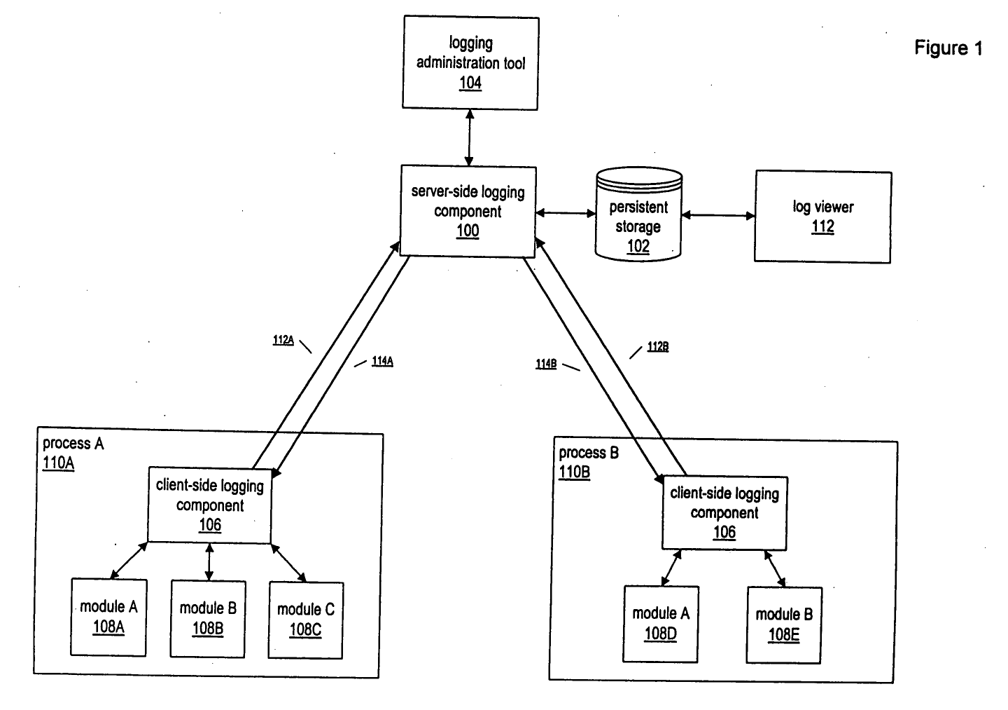

For more information on Windows programming, please refer to:
Petzold, Programming Windows, Microsoft Press, 1998.
   FIG. 1—System for Logging Events for Multiple Process

FIG. 1 is a block diagram illustrating one embodiment of a system for logging events for multiple processes. FIG. 1 illustrates processes 110. The processes 110 may be multiple processes that are associated with a particular application, or may be unrelated processes, e.g., processes associated with separate applications, or may be related to each other in some other way, e.g., as computing services that various applications utilize. As described below, the processes 110 may execute on the same computer, on different computers, or a combination of these.

As shown in FIG. 1, various modules or components 108 may be associated with each process 110. These modules may be modules or components of any type, or may simply be separate threads of execution. For example, on a Windows platform, the modules 108 may comprise various in-process Component Object Model (COM) objects, DLLs, etc. that are associated with a process.

Each module 0.108 may, at times, need to log various types of events. The modules may need to log events for any of various purposes, such as:
to record system or application performance information
to record information related to system or application security
to record debugging information
to record other informational messages regarding runtime operation of a system or application

Each event logged by a module may be associated with one or more event “categories”. Event categories may be defined in any of various ways. For example, in one embodiment, events are categorized according to the four purposes shown above. Since event categories may overlap, each event may be associated with multiple categories. For example, an event for recording memory usage information may be useful for both application performance and debugging purposes. Thus, an event mask may be used to specify the event categories that an event is associated with. For example, bit constants may be defined for each event category, such as:

| typedef enum HSCLLogType { | |
|---|---|
| HSCLSecurity | = 1, |
| HSCLOperator | = 2, |
| HSCLPerformance | = 4, |
| HSCLDebug | = 8, |
| HSCLDebugDetail | = 16 |

}

The mask may then be created by ORing together the relevant bit constants.

It is noted that, in other embodiments, events may be categorized in various ways other than the categories shown above. Also, the level of scope of the event categories may be different. For example, if desired, may more event categories may be defined in order to provide a finer level of detail what each event relates to. For example, the “performance” category shown above may be split into categories related to resource consumption, time-based information, etc. Although the particular event mask implementation shown above may only allow a limited number of event categories to be defined, event masks may, of course, be implemented in any of various other ways. For example, a hierarchical system may be used to categorize events.

Each event logged by a module may also be associated with one or more event “levels”. Event levels may specify the “importance” of an event, using any various arbitrary schemes to define this “importance”. For example, in one embodiment, four event levels are defined as follows:

typedef enum HSCLLogLevel {

| HSCLCritical | = 1, // use for more important events |
|---|---|
| HSCLLevel1 | = 1, |
| HSCLError | = 2, |
| HSCLLevel2 | = 2, |
| HSCLWarning | = 3, |
| HSCLLevel3 | = 3, |
| HSCLInfo | = 4, // use for events that are less important |
| HSCLLevel4 | = 4 |

} HSCLLogLevel;.

Each event logged by a module may also have an associated message, e.g., an informational text message, such as “Starting scheduler”. These messages may be arbitrary text strings, may be strings defined in a resource file, etc.

As shown in FIG. 1, each module or component 108 for a particular process 110 may interface with a “client-side logging component 106” associated with the process, in order to log events. The client-side logging component 106 is preferably a component or module that executes in-process with the modules 108. In other words, when functions or methods of the client-side logging component are called by a module 108, no process switch is required. In one embodiment, the client-side logging component 106 is implemented as an in-process Component Object Model (COM) object.

As indicated by the arrows 112, each client-side logging component associated with a process 110 may interface with a server-side logging component 100, in order to propagate the events to be logged. The server-side logging component 100 may execute out-of-process from the client-side logging components. In one embodiment, the client-side logging component 106 is implemented as an out-of-process COM object.

As shown in FIG. 1, the server-side logging component 100 may persistently store events received from the client side logging components 106 in some type of persistent storage 102. The server-side logging component may perform this persistent storage of events in any of various ways. For example, the server-side logging component may record the events in a log file or database. In one embodiment, the server-side logging component may interface with an external server in order to store the event information in a remote location, e.g., by communicating with the external server over a network such as the Internet.

As shown in FIG. 1, a log viewer 112 may be used to display events recorded in the persistent storage 102. The log viewer may interface with the persistent storage 102 in any of various ways, e.g., depending on whether events are logged into a flat file, a database, an external server, etc. The log viewer may be configured to display event information in any of various ways, e.g., by splitting events into their associated categories, displaying events in sequential order, separating events according to which module or application initiated the event log request,

As shown in FIG. 1, a logging administration tool 104 may be utilized in order to set event logging criteria. For example, the logging administration tool may enable an administrator to specify that only events of particular levels should be logged, or that only events associated with certain event categories should be logged, etc. The logging administration tool 104 may interface with the server-side logging component 100, in order to set the logging criteria. In response, the server-side logging component 100 may automatically propagate the logging criteria information to each of the client-side logging components 106, as indicated by the arrows 114.

The server-side logging component may interface with the client-side logging components in any of various ways in order to propagate the logging criteria information. In one embodiment, the server-side logging component and the client-side logging components are implemented as Component Object Model (COM) components, and the propagation of logging criteria information is implemented through the use of standard COM event mechanisms. For more information on communication among COM components, please refer to the above-incorporated references.

Upon receiving a request to log an event from a module 108, the client-side logging component 106 is preferably enabled to determine whether the event to be logged satisfies the logging criteria received from the server-side logging component 100. For example, if the logging criteria specify that only events of a certain level or higher are to be logged, then the client-side logging component 106 may simply ignore events of a lower level. Thus, unnecessary communication between the client-side logging components 106 and the server-side logging component 100 may be avoided, which may significantly benefit application or system performance. For example, applications often include many calls for logging low-priority informational messages, e.g., for application development or debugging purposes. An administrator may easily suspend or reinstate the logging of these types of messages, simply by setting the appropriate logging criteria.

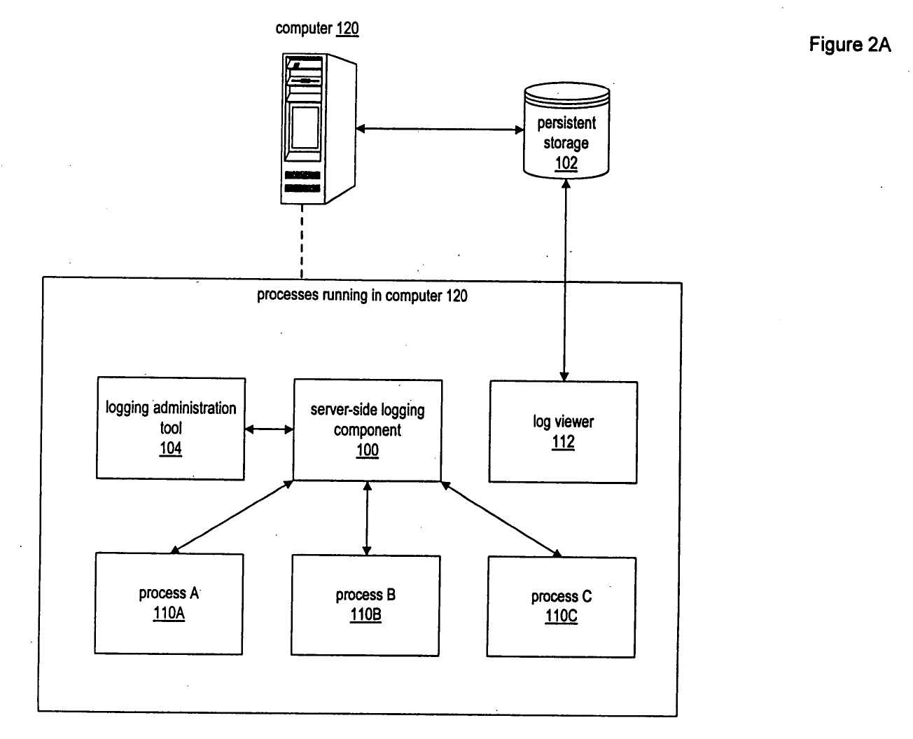

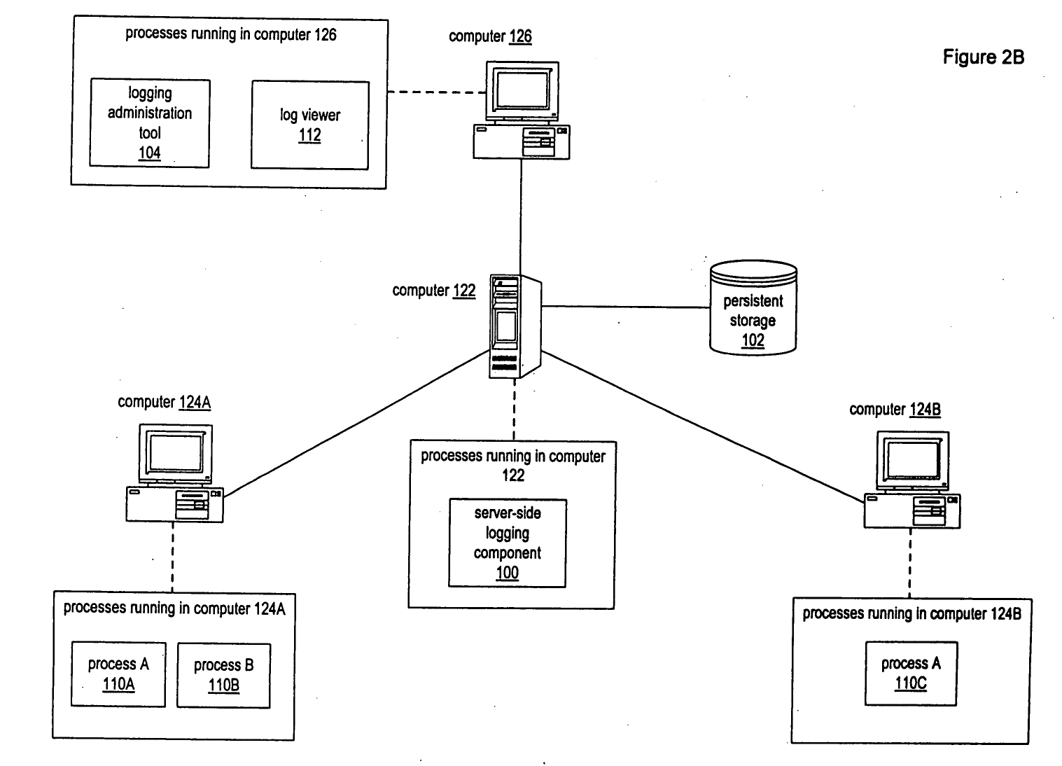

FIG. 2—Exemplary Distribution Embodiments

As noted above, various of the elements shown in FIG. 1 may execute on the same computer, on different computers, or a combination of these. FIGS. 2A and 2B illustrate exemplary embodiments of the distribution of FIG. 1 elements.

FIG. 2A illustrates an embodiment in which the FIG. 1 elements execute on the same computer 120. These elements are shown in FIG. 2A as separate processes running in the computer 120. The processes 110 shown in FIG. 2A may have an associated client-side logging component and associated executable modules or components that call the client-side logging component, as discussed above and shown in FIG. 1. In the FIG. 2A embodiment, each of the processes 110, and in particular the client-side logging component instances associated with each process 110, may communicate with the server-side logging component 100 using any of various standard inter-process communication techniques.

FIG. 1 elements may be implemented using various component software models, such as the Component Object Model (COM), the Common Object Request Broker Architecture (CORBA), the JavaBeans component model, etc. One potential advantage of implementing FIG. 1 elements as components is that the component models may enable the FIG. 1 elements to be distributed across multiple computers. FIG. 2B illustrates an embodiment in which the FIG. 1 elements execute on multiple computers.

As shown in FIG. 2B, the server-side logging component 100 may run on a computer 122. As shown in FIG. 2B, the computer 122 is connected, via a network, to computers 124 and 126. The computers may be connected through any type of network, including a LAN, a WAN, an Intranet, the Internet, a wireless network, etc., or some combination of these.

As shown in FIG. 2B, one or more processes 110 may run on each computer 124, where the processes 110 are processes such as discussed above and shown in FIG. 1. The client-side logging component instances associated with each process 110 may communicate with the server-side logging component 100 using any of various standard communication techniques and protocols. As noted above, the client-side logging components 110 and the server-side logging component 100 may be implemented according to software component models, and the components may communicate using the built-in support for distributed-communication that the component models provide. For example, in one embodiment, the components may be implemented as COM components and may communicate via support provided by the Distributed Component Object Model (DCOM). For information related to a DCOM embodiment, please refer to the above-incorporated references.

As shown in FIG. 2B, the logging administration tool 104 and the log viewer 112 may also execute on a separate computer, such as computer 126.

FIGS. 2A and 2B represent exemplary embodiments, and the systems may be modified in alternative embodiments. For example, it is noted that the embodiments of FIGS. 2A and 2B may be combined in various ways. For example, one or more client logging process 110 may also execute in computer 122 in FIG. 2B. The server-side logging component may serve requests for both processes 110 running on computer 122 and processes 110 running on separate computers. As another example, the logging administration tool 104 and/or the log viewer 112 may execute on the computer 122 or a computer 124.

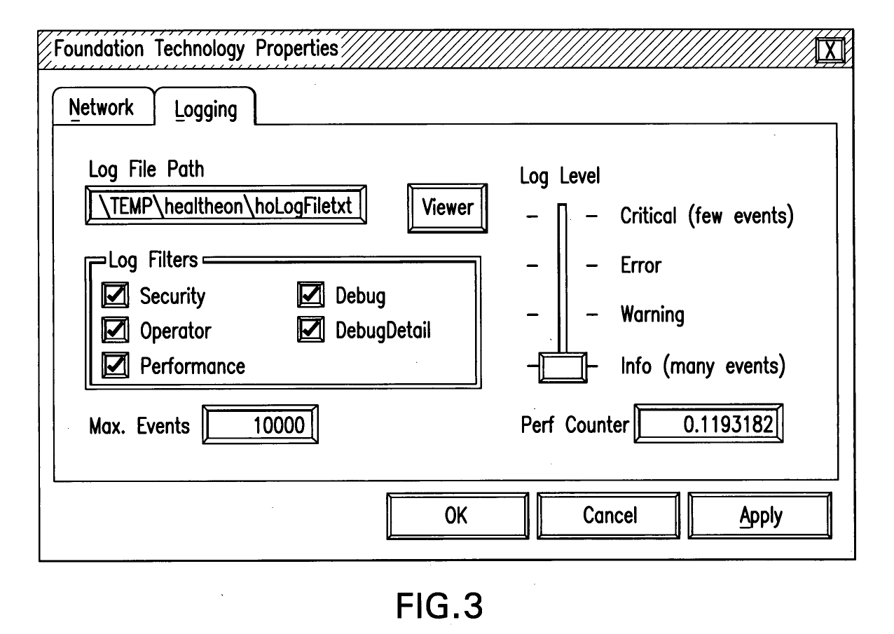

FIG. 3—Logging Administration Tool Graphical User Interface

As described, above, a user, e.g., an administrator, may utilize a logging administration tool 104 to manage event logging. The logging administration tool 104 may comprise a graphical user interface (GUI). FIG. 3 illustrates an exemplary logging administration tool GUI.

As shown in the “Log Filters” section of FIG. 3, the GUI may provide a means for specifying which event categories to log events for. The check boxes shown in FIG. 3 correspond to the exemplary event categories discussed above. As described above, an event mask may be used to specify the event categories with which an event is associated. When requesting a client-side logging component to log an event, a module may pass the event mask information to the client-side logging component. The client-side logging component may then check the event mask information to determine whether the event is associated with a category for which events should be logged.

As shown by the “Log Level” GUI control of FIG. 3, the GUI may also provide a means for specifying which event levels to log events for. This event level information may be used by client-side logging components in determining whether or not to log events, similarly as described above.

As shown in FIG. 3, the logging administration tool may also enable administrators to manage various other aspects of event logging, such as where to store event information, etc.

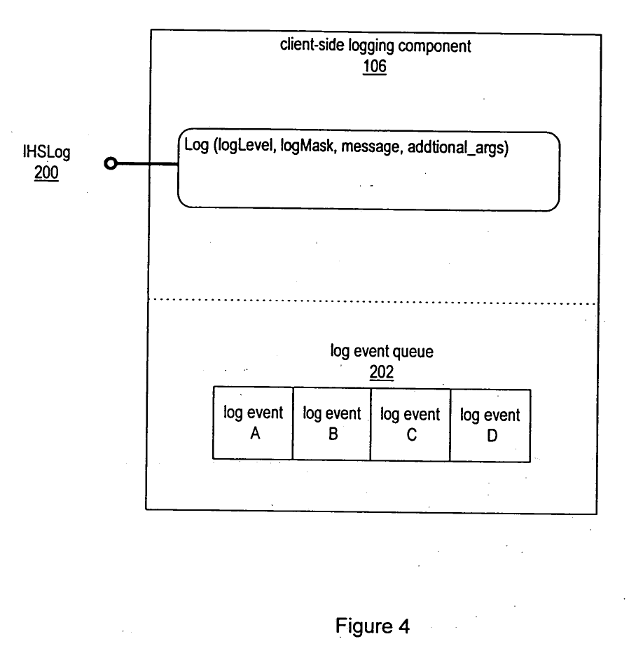

FIG. 4—Client-Side Logging Component

The client-side logging component 106 may be constructed according to any of various programming methodologies or component specifications, e.g., as a COM component, CORBA component, JavaBeans component, etc. The client-side logging component may provide various functions or methods callable by modules 108 in order to log events. FIG. 4 illustrates an embodiment in which a client-side logging component exposes an interface comprising methods for logging events. Clients, i.e., modules 108, may obtain a reference to this interface in order to use its methods.

As noted above, in one embodiment, the client-side logging component is implemented as a COM-object: Appendix A is a COM interface definition language (IDL) file illustrating a definition for an “IHSLog” interface comprising a Logo method, as well as various other methods. Client modules may obtain an IHSLog interface pointer, using standard COM methods, and call the Logo method to log an event. As noted above, the client-side logging component may execute in-process with the client module, so that no process-switch is involved in this call.

As shown in FIG. 4, in one embodiment, the client may pass parameters specifying the level and categories associated with the event to be logged. The client-side logging component may use this information as described above. The client may also pass a message, e.g., a string, to log for the event. In one embodiment, the client-side logging component enables the message to comprise printf( )-style directives, so that the message may be programmatically constructed. For example, a client may perform a log request as follows:

objLog—>Log (HSCLInfo, HSCLDebug I HSCLOperator, “Starting scheduler with % d threads”, threadCount);

where the first and second parameters specify an event level and event category mask, respectively, for the event, and the message is programmatically filled in using the threadCount integer.

As shown in Appendix A, the client-side logging component may comprise various other methods, such as methods enabling messages to be retrieved from resource files, methods enabling clients written in languages such as Visual J++ to call methods of the client-side logging component with different numbers of arguments, etc.

In one embodiment, the client-side logging component is enabled to maintain an event queue 202 for events to be logged, as shown in FIG. 4. Once the client-side logging component determines that an event satisfies the logging criteria, the client-side logging component may queue the event and immediately return control to the caller. The event may then be asynchronously retrieved from the event queue and sent to the server-side logging component for logging. Enabling logging clients to resume execution immediately in this way may advantageously benefit system or application performance.

The client-side logging component is preferably enabled to handle runtime issues regarding concurrency. For example, as shown in FIG. 1, multiple client modules may call the client-side logging component to log events. The client-side logging component may use any of various standard methods for synchronizing data access in order to properly queue events received from each of the clients.

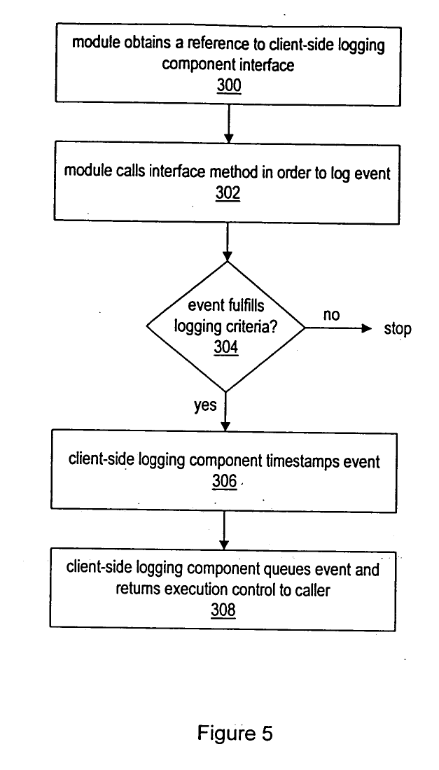

FIG. 5—Initiating an Event Log Request

FIG. 5 is a flowchart diagram illustrating one embodiment of a process of initiating a request to log an event. As shown, in step 300, a client executable module, such as a module 108 illustrated in FIG. 1, may obtain a reference to a client-side logging component interface. For example, the client-side logging component may provide an interface such as discussed above with reference to FIG. 4. The client module may obtain the reference to the interface in any way appropriate for a particular implementation.

In step 302, the client module calls an interface method in order to log an event. For example, the client may call a Logo method similar to the FIG. 4 Logo method. As discussed above, step 302 may comprise the client module passing information specifying an event level for the event, one or more event categories for the event, a message or message ID, etc. This event information may of course be wrapped in a structure or object representing the event.

As described above, the client-side logging component may maintain information specifying the types of events that should be logged. In step 304, the client-side logging component uses the information received from the client module in step 302 to determine whether the event should be logged, e.g., by determining whether the one or more event categories for the event are event categories for which events should be logged, etc. If the client-side logging component determines that the event should not be logged, then the client-side logging component may simply return execution control to the client module.

If the client-side logging component determines that the event received from the client module is an event that should be logged, then the client-side logging component may timestamp the event, as shown in step 306. For example, step 306 may involve creating a data structure representing the event, calling a system function to determine the current time, adding the time information to the data structure, etc. The server-side logging component may use the timestamp information as described below.

As shown in step 308, the client-side logging component may then queue the event and return execution control to the client module. The client-side logging component may implement the event queue using any of various well-known techniques. As discussed above with reference to FIG. 4, the client-side logging component preferably synchronizes data access and handles concurrency issues regarding queuing events for multiple client modules. As described below, the client-side logging component may then asynchronously retrieve the event from the event queue and send it to the server-side logging component.

FIG. 5 represents one embodiment of a process of initiating a request to log an event, and various steps of FIG. 5 may be added, omitted, combined, altered, etc. For example, the client-side logging component may not necessarily add timestamp information to the event in step 306, or the client module may timestamp the event itself. As another example, the client-side logging component may return execution control to the client module immediately upon being called, even before the check against the event logging criteria is performed. As another example, the client-side logging component may not queue the event in step, 308, but may synchronously send the event to the server-side logging component. However, enabling the client module to resume execution immediately may have certain performance benefits, as noted above.

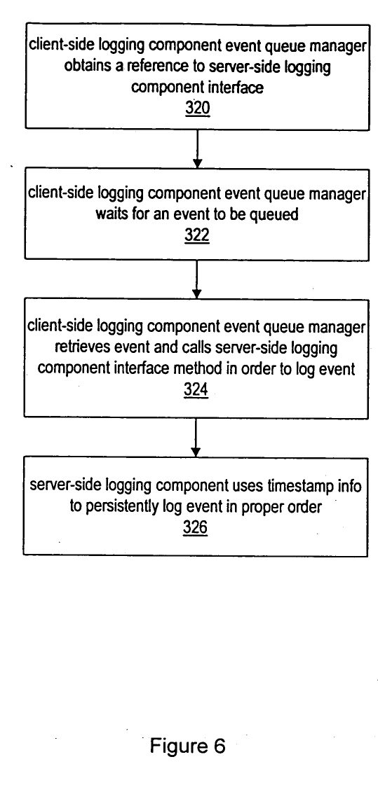

FIG. 6—Asynchronously Sending Events to Server-Side Logging Component

FIG. 6 is a flowchart diagram illustrating one embodiment of a process of a client-side logging component asynchronously retrieving events from its event queue and sending the events to the server-side logging component. FIG. 6 is illustrated in terms of an “event queue manager”, which performs this retrieval and sending of events. The event queue manager may operate in various ways. For example, in one embodiment the event queue-manager is simply a separate thread associated with the client-side logging component.

In step 320, the client-side logging component event queue manager may obtain a reference to a server-side logging component interface. For example, the server-side logging component may be implemented according to a software component model and may provide an interface for client-side logging components to use, similar to the way the FIG. 4 client-side logging component provides an interface for client modules to use. Appendix B provides a COM IDL file illustrating an exemplary definition of such an interface, for a COM embodiment of the server-side logging component. The client-side logging component event queue manager may obtain the reference to the interface in any way appropriate for a particular implementation.

In step 322, the client-side logging component event queue manager waits for an event to be queued. Step 322 may be implemented using any of various well-known techniques, as appropriate to a particular operating system, development environment, etc. For example, the event queue manager may be a thread that wakes up periodically to check for new events.

If an event is present, then in step 324 the client-side logging component event queue manager retrieves the event and uses the server-side logging component interface obtained in step 320 to call a method for logging the event. The client-side logging component may pass the server-side logging component information regarding the event, such as the event level, the associated event categories, the event message, the event timestamp, etc. This event information may of course be wrapped in a structure or object representing the event.

As noted above, in one embodiment the client-side logging component and the server-side logging component may execute on separate computers. Thus, step 324 may involve communication between separate computers. In this case, the client-side logging component and the server-side logging component are preferably implemented as components according to a software component model, and the client-side and server-side logging components may utilize built-in communication support provided by the software component model. For example, the Distributed Component Object Model (DCOM) provides support for a client to invoke a method of a component executing on a remote computer.

In step 326, the server-side logging component logs the event information received from the client-side logging component. The server-side logging component may log information such as the event message, the event level, the event categories for the event, the timestamp information, etc. The server side logging component may, of course, also log other types of information. For example, the event information received from the client-side logging component may include information identifying the module or application that initiated the log request, etc.

Similarly as discussed above, the server-side logging component is preferably enabled to handle synchronization and concurrency issues which may arise due to multiple client-side logging components calling the server-side logging component to log events. The server-side logging component may use the event timestamp information to properly order events in the event log, if necessary. Thus the event log information may account for variables such as network latencies involved in sending events from client-side logging components to the server-side logging component.

In one embodiment in which the server-side logging component is called by client-side logging components that are distributed across multiple computers, the multiple computers may be associated with a particular network. In this case, the multiple computers may have synchronized clocks, e.g., clocks that are maintained by a network operating system, for the network. Thus, the event information logged by the server-side logging component may reflect the actual order in which the events occurred as accurately as possible.

As noted above, the server-side logging component may log event information in any of various ways. Events are preferably logged persistently, e.g., by storing them in a file, a database, etc. In one embodiment, the server-side logging component may propagate the event log information to another server for remote storage.

FIG. 6 represents one embodiment of a process of a client-side logging component retrieving events and sending the events to the server-side logging component, and various steps of FIG. 6 may be added, omitted, combined, altered, etc. For example, the client-side logging component event queue manager may perform various types of optimizations in sending events to the server-side logging component. For example, the client-side logging component may send multiple events to the server in a single method call or transaction, the client-side logging component may wait until network traffic is low before communicating with the server-side logging component, etc.

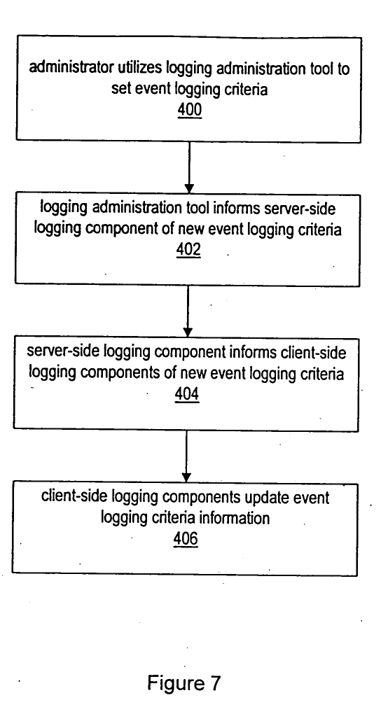

FIG. 7—Setting Event Logging Criteria

In one embodiment, a logging administration tool may be used in order to set criteria specifying which events to log, as described above. FIG. 7 is a flowchart diagram illustrating one embodiment of a process of automatically updating the event-logging criteria maintained by client-side logging components.

In step 400, a user, such as an administrator, uses the logging administration tool to set event logging criteria. As discussed above, the event logging criteria may comprise information specifying certain event levels for which events should be logged, e.g., events of a certain importance level or higher. The event logging criteria may also comprise information specifying particular event categories for which events should be logged.

In step 402, the logging administration tool informs the server-side logging component of the new event logging criteria. The logging administration tool may interface with the server-side logging component in any of various ways. For example, the logging administration tool may obtain a reference to an interface provided by the server-side logging component, similarly as described above, where the interface included methods for setting the event logging criteria. Appendix B provides a COM IDL file illustrating an exemplary definition of such an interface, for a COM embodiment of the server-side logging component.

In step 404, the server-side logging component informs the client-side logging components of the new event logging criteria. As noted above, the server-side logging component may interface with the client-side logging components in any way appropriate to a particular implementation in order to propagate the event logging criteria. In one embodiment, the server-side logging component and the client-side logging components are implemented as Component Object Model (COM) components and the propagation of logging criteria information is implemented through the use of standard COM event mechanisms. For more information on communication among COM components, please refer to the above-incorporated references.

When a client-side logging component is first instantiated and begins running, the client-side logging component may locate the server-side logging component to inform the server-side logging component of its existence. Thus the server “knows” about each of the client-side logging components at any given time. Before propagating event logging criteria to a client-side logging component, the server-side logging server may check to ensure that the client-side logging component is still functioning. In one embodiment, client-side logging components are implemented as COM objects, and the server-side logging component is automatically notified when a client-side logging component terminates, e.g., using standard COM notifications for object termination.

In step 406, the client-side logging components update the event-logging criteria information that they maintain with the new event logging criteria received from the server-side logging component. The client-side logging components may then begin using the new event logging criteria to filter events, as described above.

Although the embodiments above have been described in considerable detail, numerous variations and modifications will become apparent to those skilled in the art once the above disclosure is fully appreciated. It is intended that the following claims be interpreted to embrace all such variations and modifications.

1. A system for logging an event, comprising:
a computer system including a CPU and memory;
a server-side logging component comprised in the memory of the computer system;
a means for persistently storing information;
a first client-side logging component comprised in the memory of the computer system;
a first executable module, wherein the first executable module is executable to call the first client-side logging component in order to log an event, wherein the event comprises an event level;
wherein the first executable module calling the first client-side logging component comprises the first executable module passing information specifying the event level to the first client-side logging component,
wherein the first client-side logging component calling the server-side logging component comprises the first client-side logging component passing information specifying the event level to the server-side logging component;
wherein the server-side logging component persistently logging the event comprises the server-side logging component persistently logging the event level;
wherein, in response to said first executable module calling the first client-side logging component in order to log an event, the first client-side logging component is executable to call the server-side logging component in order to log the event;
wherein, in response to said first client-side logging component calling the server side logging component in order to log the event, the server-side logging component is executable to utilize the means for persistently storing information in order to persistently log the event.

2. The system of claim 1,
wherein the first client-side logging component maintains logging criteria information specifying which levels of events should be logged;
wherein, in response to said first executable module calling the first client-side logging component, the first client-side logging component is executable to compare the information specifying the event level to the logging criteria information, in order to determine whether the event should be logged;
wherein, if the first client-side logging component determines that the event should not be logged, the client-side logging component does not perform said calling the server-side logging component.

3. The system of claim 1,
wherein the event is associated with a first event category;
wherein said first executable module calling the first client-side logging component comprises the first executable module passing information specifying the first event category to the first client-side logging component;
wherein said first client-side logging component calling the server-side logging component comprises the first client-side logging component passing information specifying the first event category to the server-side logging component;
wherein said server-side logging component persistently logging the event comprises the server-side logging component persistently logging the first event category.

4. The system of claim 3,
wherein the first client-side logging component maintains logging criteria information specifying which categories of events should be logged;
wherein, in response to said first executable module calling the first client-side logging component, the first client-side logging component is executable to compare the information specifying the first event category to the logging criteria information, in order to determine whether the event should be logged;
wherein, if the first client-side logging component determines that the event should not be logged, the client-side logging component does not perform said calling the server-side logging component.

5. The system of claim 4,
wherein the event is also associated with a second event category;
wherein said first executable module calling the first client-side logging component further comprises the first executable module passing information specifying the second event category to the first client-side logging component;
wherein, in response to said first executable module calling the first client-side logging component, the first client-side logging component is executable to compare the information specifying the second event category to the logging criteria information, in order to determine whether the event should be logged.

6. The system of claim 1, wherein the first client-side logging component executes in-process with the first executable module.

7. The system of claim 1, further comprising:
a second executable module, wherein the second executable module is executable to call the first client-side logging component in order to log an event;
wherein the first executable module and the second executable module and the first client-side logging component run in the same process.

8. The system of claim 7,
wherein the first client-side logging component executes as an in-process COM object.

9. The system of claim 1, further comprising:
a second client-side logging component comprised in the memory of the computer system;
a second executable module, wherein the second executable module is executable to call the second client-side logging component in order to log an event;
wherein the first executable module and the first client-side logging component run in a first process;
wherein the second executable module and the second client-side logging component run in a second process.

10. A system for logging an event, comprising:
a computer system including a CPU and memory;
a server-side logging component comprised in the memory of the computer system;
a means for persistently storing information;
a first client-side logging component comprised in the memory of the computer system;
a first executable module, wherein the first executable module is executable to call the first client-side logging component in order to log an event;
wherein, in response to said first executable module calling the first client-side logging component in order to log an event, the first client-side logging component is executable to store the event in a queue and return execution control to the first executable module prior to evaluating the event;
wherein said first client-side logging component calling the server-side logging component comprises the first client-side logging component asynchronously retrieving the event from the queue and then calling the server-side logging components
wherein, in response to said first executable module calling the first client-side logging component in order to log an event, the first client-side logging component is executable to call the server-side logging component in order to log the event;
wherein, in response to said first client-side logging component calling the server-side logging component in order to log the event, the server-side logging component is executable to utilize the means for persistently storing information in order to persistently log the event.

11. The system of claim 10,
wherein said first client-side logging component asynchronously retrieving the event from the queue and then calling the server-side logging component is performed by an event queue manager thread.

12. The system of claim 1, further comprising:
a logging administration tool executable to configure the server-side logging component with event-logging criteria information, wherein the event-logging criteria information includes information specifying which levels of events should be logged;
wherein the first client-side logging component maintains logging criteria information specifying which levels of events should be logged;
wherein the server-side logging component is executable to propagate event-logging criteria information to the first client-side logging component in response to said logging administration tool configuring the server-side logging component with event-logging criteria information.

13. The system of claim 12,
wherein the first client-side logging component is executable to update the logging criteria information that it maintains, in response to said server-side logging component propagating the event-logging criteria information to the first client-side logging component.

14. The system of claim 13,
wherein the server-side logging component is a COM component;
wherein the first client-side logging component is a COM component;
wherein said server-side logging component propagating the event-logging criteria information to the first client-side logging component is performed by using COM mechanisms for sending a COM event from one COM component to another COM component.

15. The system of claim 1, the system further comprising:
a logging administration tool executable to configure the server-side logging component with event-logging criteria information, wherein the event-logging criteria information includes information specifying which categories of events should be logged;
wherein the first client-side logging component maintains logging criteria information specifying which categories of events should be logged;
wherein the server-side logging component is executable to propagate event-logging criteria information to the first client-side logging component in response to said logging administration tool configuring the server-side logging component with event-logging criteria information;
wherein the first client-side logging component is executable to update the logging criteria information that it maintains, in response to said server-side logging component propagating the event-logging criteria information to the first client-side logging component.

16. The system of claim 1,
wherein, in response to said first executable module calling the first client-side logging component in order to log an event, the first client-side logging component is executable to timestamp the event;
wherein said client-side logging component calling the server-side logging component comprises the client-side logging component passing timestamp information for the event to the server-side logging component;
wherein said server-side logging component utilizing the means for persistently storing information in order to persistently log the event comprises the server-side logging component logging the timestamp information.

17. The system of claim 16,
wherein the server-side logging component is executable to utilize event timestamp information in order to determine the order in which events should be logged.

18. The system of claim 1,
wherein the means for persistently storing information comprises an element from the group consisting of:
a file and a database.

19. A system for logging an event, comprising:
a first computer system including a CPU and memory;
a second computer system including a CPU and memory;
a server-side logging component comprised in the memory of the first computer system;
a means for persistently storing information;
a first client-side logging component comprised in the memory of the second computer system;
a first executable module running on the second computer system, wherein the first executable module is executable to call the first client-side logging component in order to log a first event;
wherein, in response to said first executable module calling the first client-side logging component in order to log a first event, the first client-side logging component is executable to call the server-side logging component in order to log the first event;
wherein, in response to said first client-side logging component calling the server-side logging component in order to log the first event, the server-side logging component is executable to utilize the means for persistently storing information in order to persistently log the first event.

20. The system of claim 19, further comprising:
a third computer system including a CPU and memory;
a second client-side logging component comprised in the memory of the third computer system;
a second executable module running on the third computer system, wherein the second executable module is executable to call the second client-side logging component in order to log a second event;
wherein, in response to said second executable module calling the second client-side logging component in order to log a second event, the second client-side logging component is executable to call the server-side logging component in order to log the second event;
wherein, in response to said second client-side logging component calling the server-side logging component in order to log the second event, the server-side logging component is executable to utilize the means for persistently storing information in order to persistently log the second event.

21. The system of claim 20;
wherein the first client-side logging component executes in-process with the first executable module;
wherein the second client-side logging component executes in-process with the second executable module.

22. A method for logging an event, comprising:
a first executable module calling a first client-side logging component in order to log an event, wherein the first executable module and the first client-side logging component are stored in the memory of a computer system and execute on the computer system;
the first client-side logging component calling a server-side logging component in order to log the event, in response to said first executable module calling the first client-side logging component, wherein the server-side logging component is stored in the memory of the computer system and executes on the computer system;
wherein the event comprises an event level;
wherein said first executable module calling the first client-side logging component comprises the first executable module passing information specifying the event level to the first client-side logging component;
wherein said first client-side logging component calling the server-side logging component comprises the first client-side logging component passing information specifying the event level to the server-side logging component;
the server-side logging component persistently storing information in order to persistently log the event, in response to said first client-side logging component calling the server-side logging component;
wherein said server-side logging component persistently logging the event comprises the server-side logging component persistently logging the event level.

23. The method of claim 22,
wherein the first client-side logging component maintains logging criteria information specifying which levels of events should be logged;
wherein, in response to said first executable module calling the first client-side logging component, the first client-side logging component compares the information specifying the event level to the logging criteria information, in order to determine whether the event should be logged;
wherein, if the first client-side logging component determines that the event should not be logged, the client-side logging component does not perform said calling the server-side logging component.

24. The method of claim 22,
wherein the event is associated with a first event category;
wherein said first executable module calling the first client-side logging component comprises the first executable module passing information specifying the first event category to the first client-side logging component;
wherein said first client-side logging component calling the server-side logging component comprises the first client-side logging component passing information specifying the first event category to the server-side logging component;
wherein said server-side logging component persistently logging the event comprises the server-side logging component persistently logging the first event category.

25. The method of claim 24,
wherein the first client-side logging component maintains logging criteria information specifying which categories of events should be logged;
wherein, in response to said first executable module calling the first client-side logging component, the first client-side logging component compares the information specifying the first event category to the logging criteria information, in order to determine whether the event should be logged;
wherein, if the first client-side logging component determines that the event should not be logged, the client-side logging component does not perform said calling the server-side logging component.

26. The method of claim 25,
wherein the event is also associated with a second event category;
wherein said first executable module calling the first client-side logging component further comprises the first executable module passing information specifying the second event category to the first client-side logging component;
wherein, in response to said first executable module calling the first client-side logging component, the first client-side logging component compares the information specifying the second event category to the logging criteria information, in order to determine whether the event should be logged.

27. The method of claim 22,
wherein the first client-side logging component executes in-process with the first executable module.

28. The method of claim 22, further comprising:
a second executable module calling the first client-side logging component in order to log an event, wherein the second executable module is stored in the memory of the computer system and executes on the computer system;
wherein the first executable module and the second executable module and the first client-side logging component run in the same process.

29. The method of claim 28,
wherein the first client-side logging component executes as an in-process COM object.

30. The method of claim 22, further comprising:
a second executable module calling a second client-side logging component in order to log an event, wherein the second executable module and the second client-side logging component are stored in the memory of the computer system and execute on the computer system;
wherein the first executable module and the first client-side logging component run in a first process;
wherein the second executable module and the second client-side logging component run in a second process.

31. A method for logging an event, comprising:
a first executable module calling a first client-side logging component in order to log an event, wherein the first executable module and the first client-side logging component are stored in the memory of a computer system and execute on the computer system;
the first client-side logging component calling a server-side logging component in order to log the event, in response to said first executable module calling the first client-side logging component, wherein the server-side logging component is stored in the memory of the computer system and executes on the computer system;
wherein, in response to said first executable module calling the first client-side logging component in order to log an event, the first client side logging component stores the event in a queue and return execution control to the first executable module prior to evaluating the event;
wherein said first client-side logging component calling the server-side logging component comprises the first client-side logging component asynchronously retrieving the event from the queue and then calling the server-side logging component;
the server-side logging component persistently storing information in order to persistently log the event, in response to said first client-side logging component calling the server-side logging component.

32. The method of claim 31,
wherein said first client-side logging component asynchronously retrieving the event from the queue and then calling the server-side logging component is performed by an event queue manager thread.

33. The method of claim 22,
a logging administration tool configuring the server-side logging component with event-logging criteria information, wherein the event-logging criteria information includes information specifying which levels of events should be logged;
the server-side logging component propagating the event-logging criteria information to the first client-side logging component in response to said logging administration tool configuring the server-side logging component with event-logging criteria information;
wherein the first client-side logging component maintains logging criteria information specifying which levels of events should be logged;
wherein the first client-side logging component updates the logging criteria information maintained by the first client-side logging component in response to said server-side logging component propagating the event-logging criteria information to the first client-side logging component.

34. The method of claim 33,
wherein the server-side logging component is a COM component;
wherein the first client-side logging component is a COM component;
wherein said server-side logging component propagating the event-logging criteria information to the first client-side logging component is performed by using COM mechanisms for sending a COM event from one COM component to another COM component.

35. The method of claim 22, further comprising:
a logging administration tool configuring the server-side logging component with event-logging criteria information, wherein the event-logging criteria information includes information specifying which categories of events should be logged;
the server-side logging component propagating the event-logging criteria information to the first client-side logging component in response to said logging administration tool configuring the server-side logging component with event-logging criteria information;
wherein the first client-side logging component maintains logging criteria information specifying which categories of events should be logged;
wherein the first client-side logging component updates the logging criteria information maintained by the first client-side logging component in response to said server-side logging component propagating the event-logging criteria information to the first client-side logging component.

36. The method of claim 22,
wherein, in response to said first executable module calling the first client-side logging component in order to log an event, the first client-side logging component is executable to timestamp the event;
wherein said client-side logging component calling the server-side logging component comprises the client-side logging component passing timestamp information for the event to the server-side logging component;
wherein said server-side logging component persistently storing information in order to persistently log the event comprises the server-side logging component logging the timestamp information.

37. The method of claim 36,
wherein the server-side logging component is executable to utilize event timestamp information in order to determine the order in which events should be logged.

38. The method of claim 22,
wherein said server-side logging component persistently storing information in order to persistently log the event comprises the server-side logging component logging the information into an element from the group consisting of:
a file and a database.

39. A method for logging an event, comprising:
a first executable module calling a first client-side logging component in order to log a first event, wherein the first executable module and the first client-side logging component are stored in the memory of a first computer system and execute on the first computer system,
the first client-side logging component calling a server-side logging component in order to log the first event, in response to said first executable module calling the first client-side logging component, wherein the server-side logging component is stored in the memory of a second computer system and executes on the second computer system;
the server-side logging component persistently storing information in order to persistently log the first event, in response to said first client-side logging component calling the server-side logging component.

40. The method of claim 39, further comprising:
a second executable module calling a second client-side logging component in order to log a second event, wherein the second executable module and the second client-side logging component are stored in the memory of a third computer system and execute on the third computer system;
the second client-side logging component calling the server-side logging component in order to log the second event, in response to said second executable module calling the second client-side logging component,
the server-side logging component persistently storing information in order to persistently log the second event, in response to said second client-side logging component calling the server-side logging component.

41. The method of claim 40,
wherein the first client-side logging component executes in-process with the first executable module;
where in the second client-side logging component executes in-process with the second executable module.
